(19) United States
(12) Patent Application Publication
(10) Pub. No.: US 2010/0089054 A1
(43) Pub. Date: Apr. 15, 2010

(54) ADAPTIVE FREE-TRAVEL REDUCTION

(75) Inventor: Heinz Leiber, Oberriexingen (DE)

Correspondence Address: CONNOLLY BOVE LODGE & HUTZ LLP, 1875 EYE STREET, N.W., SUITE 1100, WASHINGTON, DC, 20006, US

(73) Assignee: IPGATE AG, Zurich (CH)

(21) Appl. No.: 12/518,415

(22) PCT Filed: Dec. 14, 2007
(86) PCT No.: PCT/EP2007/010993

§ 371 Date: Jun. 9, 2009

(30) Foreign Application Priority Data
Dec. 15, 2006 (DE) 10 2006 059 840.7

(51) Int. Cl. B60T 13/20; B60T 13/66

(52) U.S. Cl. 60/547.1

(57) ABSTRACT

The invention relates to a brake system, an operating device, in particular a brake pedal, and a control and regulating device, wherein the control and regulating device controls a drive apparatus on the basis of the movement and/or position of the operating device, wherein the drive apparatus moves a piston of a piston/cylinder system, so that a pressure is set in the working chamber of the cylinder, wherein the working chamber is connected to at least one wheel brake via at least one pressure line, wherein the operating device acts on a pedal tappet and moves said pedal tappet, and the pedal tappet is connected to a travel simulator and acts on a displaceably mounted coupling element by means of a spring, wherein the pedal tappet and the coupling element are locked to one another by means of a fixing device, wherein the coupling element can be locked or fixed to and/or released or disconnected from the panel tappet by means of the fixing device optionally in any desired positions or in at least two different positions relative to said pedal tappet.

The present invention relates to a brake system according to the preamble of Claim 1.

Conventional brake boosters (BB) are known as so-called slave boosters in which the pedal travel is proportional to the piston travel of the main brake cylinder. In addition, there are increasingly systems with a so-called travel simulator, in which the above-mentioned classification no longer applies. Such a system is described as a so-called “Elektrohydraulische Bremse (EHB)” (electrohydraulic brake) in the Bremsenhandbuch 2nd edition, Vieweg Verlag, pp 251 and 252, which has not yet been optimized in all of its functions.

For various functions of the brake system, the travel simulation systems (pedal stroke simulator systems) require free travel between the pedal tappet and the BB tappet or piston. This is described in WO 2004/005095 A1. A means reducing the free travel in case of failure of the brake booster BB is proposed therein. This means does not have any effect if the BB failure occurs during braking because in that case, the means cannot be introduced into the smaller free-travel gap. Extremely critical is the case of full-power operation of the travel simulator and thus of the free travel approaching 0 and failure of the BB, even more extreme is additional brake circuit failure. In that case, a normal driver cannot generate sufficient braking action due to the pedal travel being too large or the brake pressure being too low, because the ergonomic limit is approximately 60% of pedal stroke. This means that a means which begins to work only at full-power operation of the travel simulator does not have a sufficient effect.

A more advanced travel simulator system that does not comprise any “means” for free-travel reduction without the ABS function having a retroactive effect on the pedal is described in DE 10 2005 018 649.1. DE 10 2005 059 609.6 describes a system with an idle stroke which is only effective during ABS function. For this purpose, a comparison must be made of the travel simulator travel with the piston position. If the distance is small, the free travel is then switched on. If the brake booster BB fails during a normal braking process, no free travel is going to have a negative effect. In an extreme case, when the brake booster fails on ice, only small blocking pressures, i.e. pedal travel, are necessary anyway, so that a smaller effective piston travel has no adverse effect in this case. This system has only one latching position.

Object

It is the object of the invention to provide a system based on DE 10 2005 059 609.6, in which there is no pedal reaction during ABS operation and which, at the same time, has a smaller idle stroke when the motor or the electric power supply fails, and which has small dimensions.

According to the invention, this object is achieved with a brake system comprising the features of claim 1. Other advantageous developments of the brake system according to claim 1 become apparent from the features of the dependent claims.

It is the basic idea of the invention to use a coupling element between the pedal tappet and the BB tappet, said coupling element normally being unlatched. In critical situations, such as for example the failure of the brake booster (BB), the coupling element can be locked continuously or in one or more positions. Preferably, this coupling element with a latching element can be designed to be actuatable electromechanically, but also piezoelectrically or electrohydraulically. Other principles of operation are conceivable. For example, the locking mechanism can be realized by means of guide curves. In the electromechanical design, the coupling element can be latched with a toothing of the pedal tappet by means of a latching element, with the size of the free travel being dependent upon the relative position of the coupling element relative to the pedal tappet. If latching takes place at the front final position of the coupling element relative to the pedal tappet, then there is no free travel. If the stroke of the pedal tappet is larger than the piston stroke, for example in the case of ABS operation and smaller pressures, the coupling element is moved back as far as the piston position allows. If the BB now fails during a normal braking process, no free travel is generated because the coupling member is latched. During ABS operation, the BB is locked in the corresponding or current piston position in the case of failure.

Thus, an adaptive free-travel adjustment advantageously takes place.

For latching, a lifting magnet is operated which moves the latching element into or out of the latch. Instead of the latch, a complex continuous solution with a self-locking wedge action is also conceivable.

The switching of the lifting magnet can be configured in various ways. It is possible, for example, that the lifting magnet is not supplied with current during the normal braking process, i.e., the latching element is not latched. It is also possible to supply the lifting magnet with current during the normal braking process. It is ensured in any case that the fallback level is failsafe in case of failure of the BB or the power supply. Furthermore, it is advantageous if the latch can be diagnosed by means of a sensor, for example by a switching signal of a switch.

In another embodiment, the unlatching stroke can be used for actuating a stop for the pedal tappet in order to prevent that the travel simulator is powered too strongly during the ABS function and at small pressures, i.e. small pedal stroke. This is advantageous in that sufficient pedal stroke is available for obtaining sufficient braking action in the unlikely case of a double error condition of a failure of the brake booster with simultaneous failure of the brake circuit and simultaneous ABS control.

In the prior art, the travel simulator is arranged separately or axially parallel. However, according to the invention the travel simulator can also be arranged coaxially with the brake booster and the piston/cylinder system (H2 piston), with the latching advantageously taking place on a part of the travel simulator, said part being connected with the pedal tappet. The pedal tappet can also be configured as a part of the travel simulator. Advantageously, the latch can be provided within the travel simulator. This has considerable advantages with regard to cost and weight.

Advantageously, the switching magnet can be attached to the travel simulator housing and does not move during the braking process, therefore, cabling does not have to extend through the pedal stroke but can be connected in that position.

All of the following advantages can be implemented with this concept:
Optimum pedal characteristic, i.e., blocking pressure is reached at approx. 30-40%, and the double blocking pressure for, e.g., fading, is reached at 40-50% using small forces exerted by the foot (the conventional booster requires large forces exerted by the foot, because the point of full-power operation is at blocking pressure without fading. Doubling the point of full-power operation would lead to very large dimensions in vacuum BBs. With ESP systems, the high pressure level is achieved by pumping with low forces exerted by foot, with, however, a delay in time limited by the pump performance. This leads to an increase in braking distance.
no brake pedal drop in case of brake circuit failure;
in case of fading at the same force exerted by the foot, the pressure can be adapted by taking into account e.g. vehicle deceleration;
no pulsating pedal in case of ABS function;
in vehicles with regenerative braking, the pressure is adapted to the braking torque of the generator, similar to fading;
during the evaluation of the pedal travel and the piston travel, a diagnosis of the brake circuit with regard to venting and leaks is automatically carried out;
by decoupling from the pedal travel, pistons with a small diameter can be used which makes considerably smaller forces of the foot possible in the case of a BB failure, the so-called transmission step;
in the case of an accident, in particular in the case of braking on ice, the pedal travel in the conventional system is small, and the crash forces act fully on the foot. In the travel simulation system, a larger pedal travel until locking is available. In addition, locking can be switched off in accordance with DE 10 2005 059 609.6 (E91), so that an even larger pedal travel is available.
extremely fail-safe.

Various possible developments of the brake system according to the invention are explained below with reference to drawings.

In the figures:

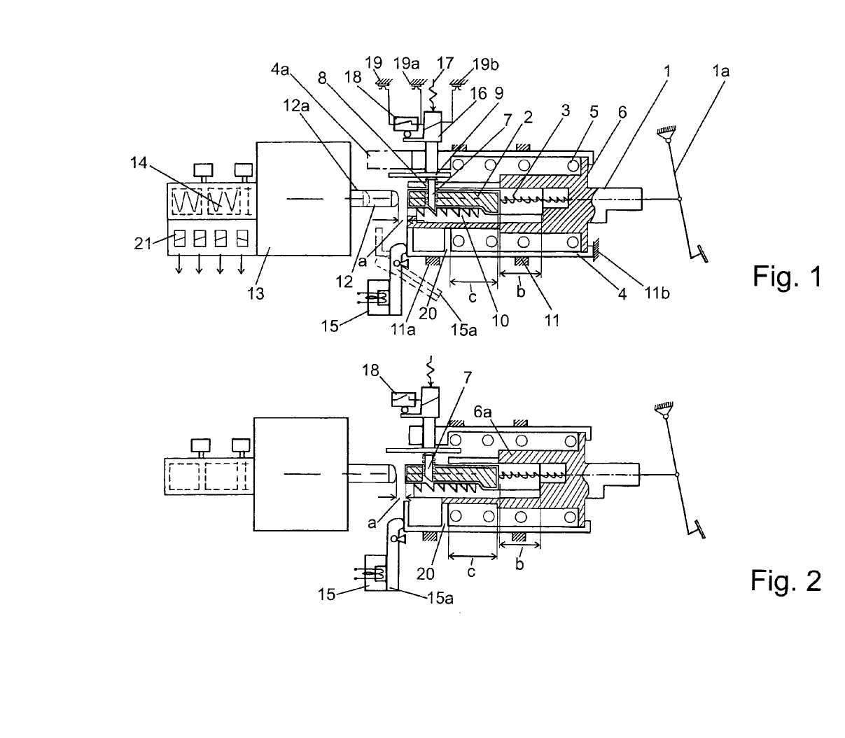

FIG. 1: shows the basic assembly with a current-free latching during the normal braking process;

FIG. 2: shows the basic assembly with a current-supplied switching element during the braking process;

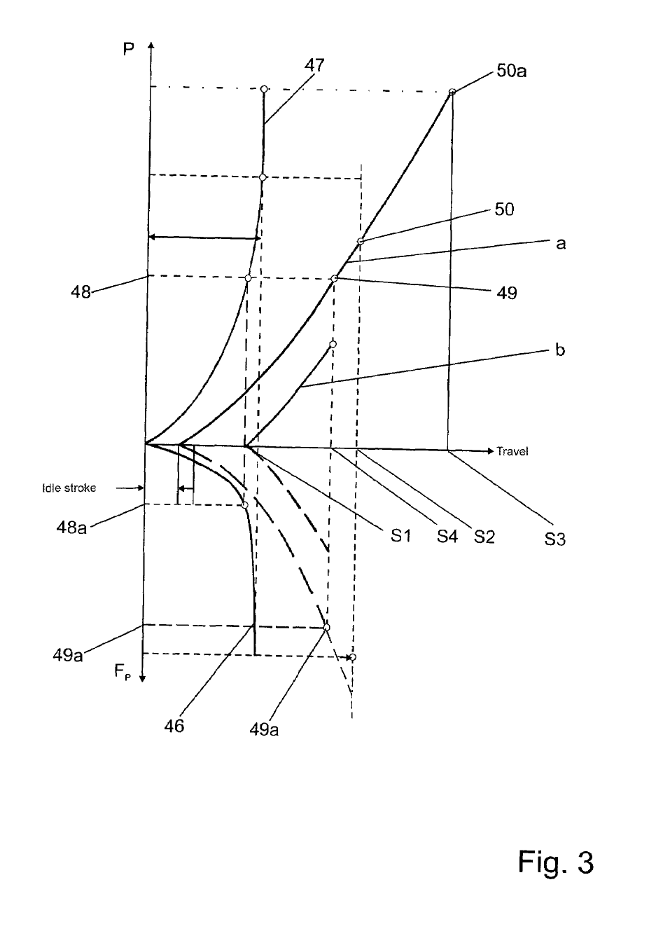

FIG. 3: shows the pedal characteristic;

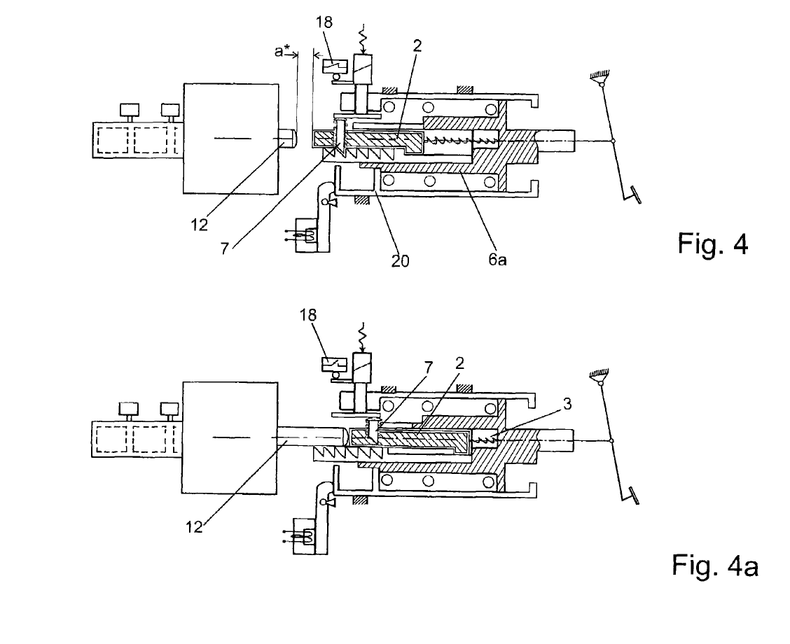

FIG. 4: shows the switching position according to the concept from FIG. 1 with a powered travel simulator, i.e. during full braking;

FIG. 4a: shows the switching position according to the concept from FIG. 1 with a powered travel simulator during ABS operation;

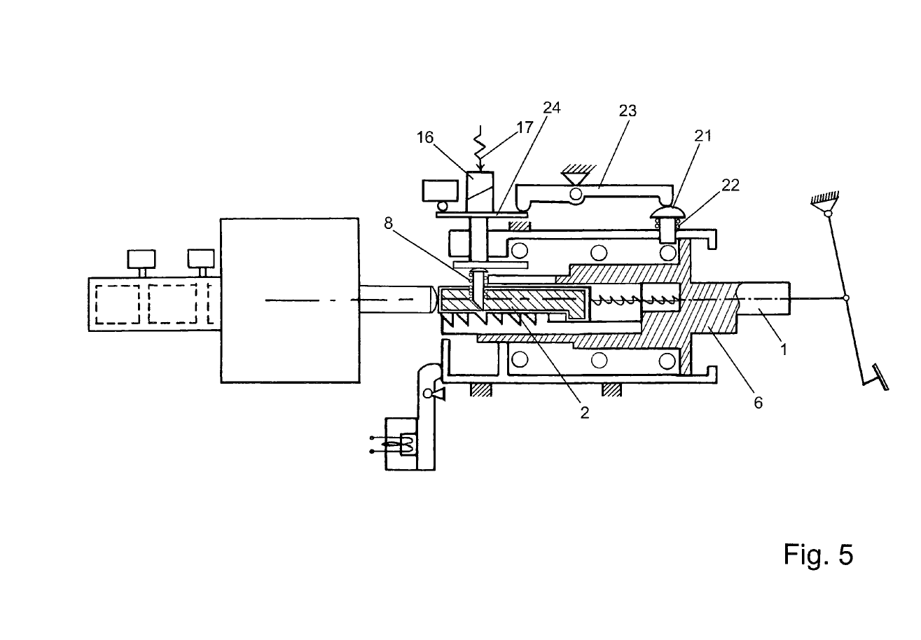

FIG. 5: shows the shortening of the stroke of the travel simulator by a stop member.

FIG. 1 shows the basic assembly of a first possible embodiment of the brake system according to the invention. The pedal tappet 1 transfers the force of the pedal 1a via the latch 10 and the latching element 7 onto the coupling member 2 to the brake booster tappet 12. The BB can be configured with hydraulic, pneumatic or electromotive actuators. A flange 6 acting on the travel simulator spring 5 that generates the known pedal force characteristic via several spring elements (not shown) is connected with the pedal tappet 1. This spring 5 is accommodated in the travel simulator housing 4 and is supported on the bottom 20 of the travel simulator housing. In the case of a functional BB, the housing 4 is locked by a lever of the magnet 15. This function is described in DE 100 2005 018 649.1. The travel simulator housing is guided in the bearings 11 and 11a.

The BB 13 is driven in the known manner by the pedal sensor not shown. The force of the BB 13 is transmitted onto the main brake cylinder pistons. In the present case, this is a tandem main cylinder. If necessary, the latching element 7 can be moved out of the latch by means of a return spring 8 (in addition, see FIG. 4a) when the magnetic force of the lifting magnet 16 is larger than the strong magnetic return spring 17. Preferably, the force is transmitted by means of a rotatable rocker or disc 9, the support of which is not shown. That is required because the position of the latching element is dependent on the position of the coupling element, as will be shown in FIGS. 4 and 4a. In the embodiment shown, the lifting magnet 16 is without current during the braking process. The lifting magnet 16 is supported in or on the travel simulator housing 4 and only moves with the housing 4 when the BB fails. Thus, the electrical connection can be easily configured because current must be transmitted in this position.

Next to the lifting magnet 16, there is a position switch 18 which is locked, for example, in the case of a latched position. Functions important with regard to safety can be diagnosed thereby, for example at the start of driving. In the process, the functions of the latching element as well as that of the lifting magnet with the return spring and of the switch and the connection are checked. When the magnet 16 is activated, the switch must supply the OFF signal. When the BB fails, the locking magnet 15 is not active so that the housing 4 of the travel simulator can be moved left in the direction of the BB tappet 12. The pedal force can thus be transmitted from the pedal tappet 1 via the latch 7, 10 directly via the BB tappet 12 to the pistons of the BB, so that a corresponding travel of the BB tappet and also a piston travel with the corresponding brake pressure is generated dependent on the force exerted by the foot. This position is drawn in chain-dotted lines and annotated with 4a, 12a and 15a.

The function of latching and unlatching through the switching magnet is described in the following Figures. The coupling element described can be also designed according to the piezoelectric, electro hydraulic or a similar principle of operation. The travel simulator housing 4 has a stopper in 11b. The restoring forces are not depicted. For example, the brake pedal can be used with its return spring, which is not depicted.

FIG. 2 shows the basic function with a modified activation of the switching magnet 16. In this case, current is supplied to it right at the beginning of the braking process, that means, that the latching element unlatches. The function is reported to the electronic controlling device not shown by means of the OFF signal of the switch 18. The switching magnet 16 is switched off on failure of the BB, which leads to latching. The travels b and c are also drawn into the FIG. 2. In this case, b denotes the travel of the coupling member which is required so that that there is no reaction on the pedal during ABS control (see FIG. 4a). C denotes the total travel of the travel simulator that the flange bushing 6a can run though to the bottom 20 of the travel simulator housing. In this case, reference is made to the description of FIG. 4. The distance b must be at least equal to the distance c.

FIG. 3 shows various characteristic curves describing pedal force and booster characteristic. The characteristic curves cannot be viewed together, because actually, different diagrams are shown superimposed one above the other. Nevertheless, the characteristic curves are described together in context below.

Characteristic curve 46 shows the pedal force as a function of the pedal travel. Characteristic curve 47 shows the brake pressure as a function of the pedal force. Operating point 48a shows the pedal force around the blocking pressure 48 on a dry road. At a travel s, the pedal travel is limited by the stopper or lock of the travel simulator. These curves apply for intact boosting, i.e. electromotor and power supply. Curve a shows the piston travel as a function of the brake pressure. This comes to act only after the small idle stroke a. The travel simulator is fully powered at s₁ and is also locked here. This characteristic curve also applies as a pressure/volume characteristic curve at a given surface area of the piston. It is important with regard to the described function of the electromotor for variable pedal force-dependent pressure boosting. In travel s₂, the pedal stroke is limited when the lock of the travel simulator is switched off. S₃ is reached by the above-described decoupling of the pedal travel and the piston travel. When the power supply fails, the blocking pressure 49 is reached at a greater pedal travel s₄ and very high pedal force 49a, for example. Maximum pressure, which however requires very high pedal forces, is reached at 50. As a rule, however, the blocking limit is far from being reached with the foot or pedal forces, in accordance with statutory provisions. However, in the normal case of intact boosting, higher pressures must be possible, for example for fading. This is accomplished by limiting piston travel not until s₃ and reaching a high pressure level 50a. This clearly shows the advantages of decoupling pedal stroke and piston stroke from each other, which comprises the so-called transmission step. The pedal forces for the corresponding pressure normally increase by the factor 5, which is felt by the driver because of a hard pedal and which irritates him, and which sometimes causes accidents. In contrast, the factor can be reduced to 2.5 by the transmission step. As was already described, the latching element can be locked or released electromagnetically. Whereby the idle stroke can be increased. If the power supply fails during adjustment to small p, then sufficient pressure can be generated up to s₂, according to the characteristic curve.

In contrast to this case, unlatching does not become necessary during a normal braking process because, according to the curve a, piston travel is always larger than the travel simulator travel which is limited at s₁. Thus, full piston travel minus the small idle stroke a is available in any case should the BB fail. This is necessary in the case of rapid pedal actuation in order to prevent the coupling element from impacting on the BB tappet. This free travel can be selected to be smaller in the concept according to FIG. 2, because the unlatching time is smaller than the motor start-up.

FIG. 4 shows the position during full braking with the concept according to FIG. 1. At full-power operation, the free-travel a corresponds to the operating point 50a with the corresponding position of the BB tappet 12 in FIG. 3. The flange bushing 6a of the travel simulator is at the stop 20, the latching element 7 is latched, switch 18 outputs the signal “ON”. No free travel is created when the BB fails, practically the full pedal stroke is available.

FIG. 4a shows the position of the piston or the BB tappet, respectively. In a borderline case, the piston travel is only approximately 6 to 8 mm at, for example, a pressure level of 10 bar. In that case, the latching element is unlatched and the coupling member 2 is almost at the stop of the pedal tappet. With a strong spring 3, the piston movement can be transmitted onto the pedal in accordance with the pressure modulation. If the BB fails in this position, the pedal force is directly transmitted onto the BB tappet 12. However, full pedal stroke, which, however, is dependent on the level of operation of the travel simulator, is not available. Even in the worst case, that is, full-power operation of the travel simulator, sufficient pressure is available for braking on ice.

The present concept satisfies all functional requirements while being highly failsafe and/or comprising backup functions for failure incidents. Moreover, there is a high potential for shortening the braking distance by fast and variable pressure change speeds.

FIG. 5 shows an enhancement for the above-mentioned extreme case of a double error condition. The system based on FIG. 1 is shown in a partial braking position in which the ABS function sets in already at small pressures, for example on ice. As described in FIGS. 1 and 4a, unlatching is effected by means of the lifting magnet 16, so that the coupling element 2 is freely moveable. The corresponding stroke of the lifting magnet 16 is transmitted via a catch 24 onto a lever 23, which engages a latching bolt 21 blocking the movement of the pedal tappet 1 with the flange 6. This prevents the travel simulator from being powered too strongly, which in the case of a fault would mean a loss of piston travel when the BB fails. If the ABS function is completed, the strong return spring 17 of the lifting magnet 16 causes latching and the return spring 22 moves the latching bolt 21 into the initial position, so that the movement of the pedal tappet 1 and thus the function of the travel simulator is cleared. It is advantageous to evaluate the position of the pedal tappet and the piston or the BB tappet, respectively, during this function. Unlatching is appropriate only given a small distance.

### REFERENCE NUMERALS

1 Pedal tappet

1a Pedal

2 Coupling element

3 Return spring

4 Travel simulator housing

4a Position of simulator housing at brake booster (BB) failure

5 Travel simulator spring

6 Flange

6a Flange bushing

7 Latching element

8 Return spring

9 Rocker

10 Latch

11 Bearing

11b Stopper

11a Bearing

12 BB tappet

12a Position of BB tappet at BB failure

13 BB (Brake Booster)

14 Tandem main cylinder

15 Travel simulator locking magnet

15a Position of anchoring lever at BB failure

16 Lifting magnet

17 Magnet return spring

18 Switch

19 Connection

19a Connection

19b Connection

20 Stopper travel simulator

21 Latching bolt

22 Return spring

23 Lever

24 Catch

46 Pedal force/travel curve

47 Brake pressure/travel curve

48 Blocking pressure on dry road

48a Pedal pressure of dry road

49 Blocking pressure at BB failure

49a Pedal force at BB failure

50 max. pressure at high pedal forces failure BB

50a Pressure level

1. A brake system, comprising an actuating device, in particular a brake pedal, and a control device, wherein the control device controls a drive device based on the movement and/or position of the actuating device, wherein the drive device shifts at least one piston of the piston/cylinder system so that a pressure is set in the working chamber of the cylinder, wherein the working chamber is connected with at least one wheel brake via at least one pressure line, wherein the actuating device acts on a pedal tappet and shifts it, and the pedal tappet is connected with a travel simulator and acts on a displaceably supported coupling element via at least one spring, wherein the pedal tappet and the coupling element can be locked relative to each other by means of a fixing unit, characterized in that the coupling element can be locked or fixed to and/or released or disconnected from the pedal tappet by means of the fixing unit optionally in any position or in at least two different positions relative to said pedal tappet.

2. The brake system according to claim 1, wherein the fixing unit has a latching element, in particular in the form of a pawl, which is movably mounted, in particular displaceably mounted, in or on the coupling element, and that the latching element cooperates with a plurality of undercuts, in particular in the form of a, in particular sawtooth-shaped, toothing of the first pedal tappet.

3. The brake system according to claim 1, wherein the fixing unit comprises a pressure part, in particular in the form of a wedge or friction surface, which is movably mounted, in particular displaceably mounted, in or on the coupling element, and that the pressure part cooperates with a pressure surface of the pedal tappet in such a way that the coupling element and the pedal tappet can be fixed relative to each other in a non-positive connection by the pressure part.

4. The brake system according to claim 1, wherein the pedal tappet is a part of the travel simulator.

5. The brake system according to claim 4, wherein the pedal tappet is inserted in the travel simulator housing, and that at least one compression spring is supported with its one end on the pedal tappet, in particular on a collar formed onto it, and with its other end on the bottom of the travel simulator housing.

6. The brake system according to claim 5, wherein the pedal tappet is configured as a piston and is displaceably mounted in the travel simulator housing configured as a cylinder.

7. The brake system according to claim 2, wherein the coupling element is disposed, at least in some areas, in the travel simulator housing and/or, at least in some areas, displaceably in a frontal opening of the pedal tappet configured as a piston, in particular axially or coaxially relative to the brake booster tappet.

8. The brake system according to claim 7, wherein the coupling element is a bolt-shaped profiled part or a plate-shaped part.

9. The brake system according to claim 2, wherein the latching element is pressurized in the direction of the unlatched position by a latching element return spring, wherein the compression spring is supported with its one end on the coupling element and with its other end on the latching element.

10. The brake system according to claim 2, wherein the fixing unit comprises an abutment part, in particular in the form of a rocker or plate, which is displaceable in the direction of movement of the latching element, and that the latching element is pressurized against the abutment part and can slide along it.

11. The brake system according to claim 10, wherein the bearing of the abutment part is disposed on the travel simulator housing or stationary relative to the piston/cylinder system.

12. The brake system according to claim 10, wherein at least one abutment spring, in particular compression spring, pressurizes the abutment part the direction of the latching element.

13. The brake system according to claim 11, wherein a drive unit, in particular in the form of an electromagnet, a guiding surface or an electrohydraulic drive, disposed on the travel simulator housing or stationary relative to the piston/cylinder system, shifts the latching element into the latching position and/or out of it.

14. The brake system according to claim 11, wherein at least one guiding surface, together with the moving travel simulator housing, shifts the abutment part.

15. The brake system according to claim 13, wherein the drive unit or the guiding surface shifts the abutment part only in one direction, and that the movement of the latching element and/or the abutment part into the other direction takes place because of a spring force.

16. The brake system according to claim 9, wherein the spring forces of the latching element return spring and the abutment spring are designed such that the latching element is pressurized in the latching position when the drive unit is not activated.

17. The brake system according to claim 2, wherein the toothing of the pedal tappet is configured in a saw-tooth shape, with the vertical flanks of the toothing pointing in the direction of the piston/cylinder system, and wherein the latching part, during movement of the first travel simulator part away from the piston/cylinder system, can be shifted from one latched position into a next latching position because of the oblique tooth flanks.

18. The brake system according to claim 2, wherein a coupling element compression spring is supported with its one end on the pedal tappet and with its other end on the coupling element and pressurizes it in the direction of the BB tappet.

19. The brake system according to claim 1, wherein the electromagnet of the fixing device is a pulsed magnet with reduced holding current.

20. The brake system according to claim 1, wherein a sensor, in particular switch, determines the position of the latching element or the position of the abutment part.

21. The brake system according to claim 1, wherein the fixing unit shifts a stopping member, in particular in the form of a latching bolt, which limits the stroke of the pedal tappet relative to the travel simulator housing.

22. The brake system according to claim 21, wherein the latching bolt can be shifted by movement of the abutment part into the latching position by means of a transmission, in particular a rocker, into the trajectory of the pedal tappet within the cylinder of the travel simulator housing, such that the movement of the pedal tappet relative to the travel simulator housing is blocked.

23. The brake system according to claim 1, wherein a locking device locks the displaceably mounted travel simulator housing in a normal position, wherein the lock can be released in case of a failure and the travel simulator housing is displaceable by means of the actuating device in the direction of the BB.

24. The brake system according to claim 1, wherein the drive device is an electromotively driven drive device.
